(19) United States
(12) Patent Application Publication
(10) Pub. No.: US 2024/0349433 A1
(43) Pub. Date: Oct. 17, 2024

(54) PORTABLE POWER SUPPLY WITH REMOVABLE OUTLET PANEL

(71) Applicant: MILWAUKEE ELECTRIC TOOL CORPORATION, Brookfield, WI (US)

(72) Inventor: Jacob R. Wenzlick, Milwaukee, WI (US)

(21) Appl. No.: 18/633,163

(22) Filed: Apr. 11, 2024

Related U.S. Application Data
(60) Provisional application No. 63/495,868, filed on Apr. 13, 2023.

(51) Int. Cl. H05K 5/02; H01M 50/204; H02B 1/04; H02G 3/08; H02J 7/00

(52) U.S. Cl. CPC H05K 5/0217; H01M 50/204; H02B 1/04; H02G 3/08; H02J 7/0013; H02J 7/0042

(57) ABSTRACT

A portable power supply including a housing in which a cavity is defined, a plurality of battery cells that are disposed in the housing, and an outlet panel assembly that is removably coupled to the housing. The outlet panel assembly includes a panel, an outlet that is mechanically coupled to the panel and electrically coupled to the battery cells, and a current interrupt circuit that is mechanically coupled to the panel and electrically coupled to the plurality of battery cells and to the outlet.

### CROSS-REFERENCE TO RELATED APPLICATIONS

This application claims priority to co-pending U.S. Provisional Patent Application No. 63/495,868, filed on Apr. 13, 2023, the entire content of which is incorporated by reference herein.

### BACKGROUND

The present disclosure relates to a portable power supply, and, in particular, a portable power supply with an electrical interruptive structure coupled to a modular outlet panel.

### SUMMARY

A portable power supply may include a modular outlet panel that is removable from the portable power supply to service the portable power supply and modular outlet panel. The portable power supply includes an electrical interruptive structure that interrupts current flowing to the outlets when an overcurrent condition, e.g., a ground leakage, occurs. The electrical interruptive structure is coupled to the modular outlet panel for removal with the modular outlet panel.

The disclosure provides, in one aspect, a portable power supply including a housing, a plurality of battery cells, and an outlet panel assembly. A cavity is defined in the housing. The battery cells are disposed in the housing. The outlet panel assembly is removably coupled to the housing and includes a panel, an outlet, and a current interrupt circuit. The outlet is mechanically coupled to the panel and electrically coupled to the battery cells. The current interrupt circuit is mechanically coupled to the panel and electrically coupled to the plurality of battery cells and to the outlet.

The disclosure provides, in another aspect, an outlet panel assembly that includes a panel, an outlet, a switch, and a current interrupt circuit. The outlet, switch, and current interrupt circuit are coupled to the panel and the current interrupt circuit is disposed at least partially between the outlet and the switch.

The disclosure provides, in another aspect, a portable power supply including a housing, a plurality of battery cells, a junction box, an outlet panel, an outlet, and a current interrupt circuit. The housing includes a cavity in which the battery cells are disposed. The junction box is coupled to the housing and includes a plurality of walls that define a recess which is separated from the cavity by the walls. The outlet panel defines a rear side that faces the recess when the outlet panel is coupled to the junction box. The outlet panel at least partially covers the recess. The outlet is coupled to the outlet panel and is electrically coupled to the plurality of battery cells. The current interrupt circuit is coupled to the outlet panel and electrically coupled to the outlet and the battery cells.

Other features and aspects of the disclosure will become apparent by consideration of the detailed description and accompanying drawings.

### BRIEF DESCRIPTION OF THE DRAWINGS

FIG. 1 is a front elevation view of a portable power supply according to embodiments disclosed herein.

FIG. 2 is a detailed perspective view of the portable power supply of FIG. 1, showing the outlet panel removed.

FIG. 3 is an exploded perspective view of a junction box and outlet panel of the portable power supply of FIG. 1.

FIG. 4 is a perspective view of a typical circuit breaker.

FIG. 5 is a detailed rear perspective view of an outlet panel of the portable power supply according to embodiments disclosed herein.

FIG. 6 is a front elevation view of the outlet panel of the portable power supply of FIG. 5.

FIG. 7 is a front perspective view of a current interrupt circuit according to embodiments disclosed herein.

FIG. 8 is a front elevation view of a current interrupt circuit according to embodiments disclosed herein.

### DETAILED DESCRIPTION

Before any embodiments of the disclosure are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

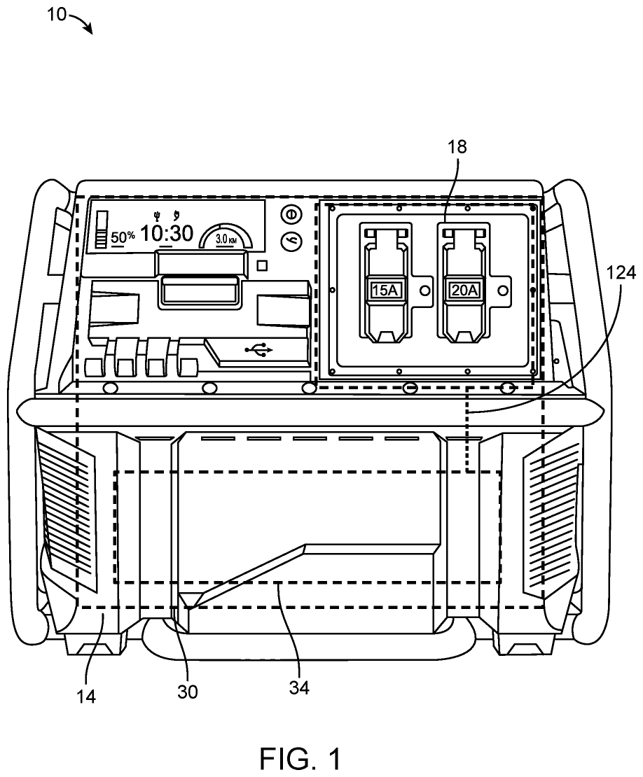

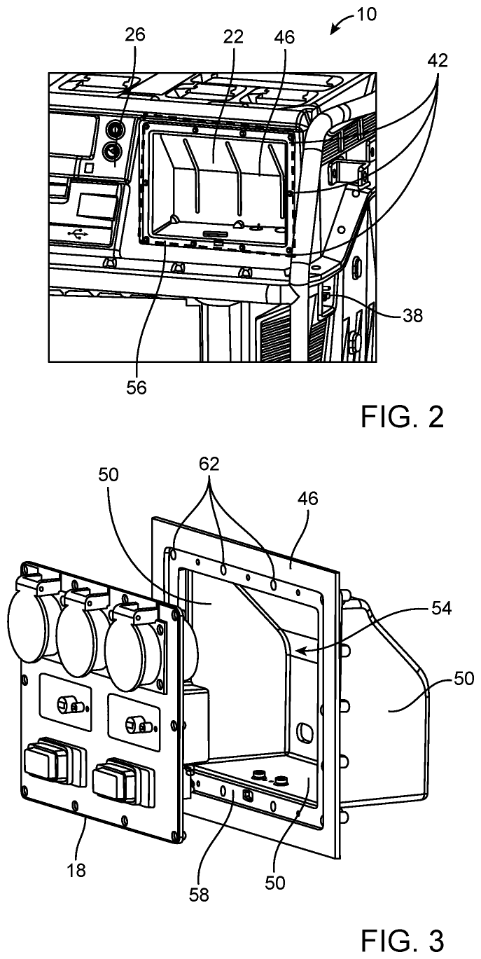

FIGS. 1 and 2 illustrate an embodiment of portable power supply 10. The portable power supply 10 has a housing 14 and an outlet panel assembly 18 attached to the housing 14. The outlet panel assembly 18 may be a modular outlet panel assembly, that is, an outlet panel assembly that is replaceable by another outlet panel assembly having a similar or different configuration. The portable power supply 10 is suitable for providing power at a remote location such as a worksite. Where a permanent power supply such as mains power is not available, and power is required in order to operate electrically powered tools, the portable power supply 10 may provide power to be used by those tools. The portable power supply 10 may provide alternating current (AC) power to tools such as corded drills, saws, and the like and battery-charging units and/or direct current (DC) power for DC-powered tools. The housing 14 of the portable power supply 10 has an opening 22, for instance at the front face 26, and a cavity 30 inside the housing 14. The housing 14 is a durable material, such as metal, plastic, or the like, that is capable of withstanding scratches, dents, or other similar wear common to a worksite. Disposed in the cavity 30 is a plurality of battery cells 34, for instance, lithium-ion battery cells or the like. The battery cells 34 are capable of being recharged, for instance by using mains electric power as a power source to recharge the battery cells 34. As shown in FIG. 2, a receptacle 38 is disposed in the housing 14 and is electrically coupled to the battery cells 34 to facilitate charging of the battery cells 34. An external power source such as mains electric power is coupled to the receptacle 38 by a power cord or other power transmission apparatus. In such embodiments, an inverter may be included to convert the AC power to DC power to charge the battery cells 34. An example of a portable power supply according to the present disclosure is described in U.S. patent application Ser. No. 17/969,222, applied for on Oct. 19, 2022, the entire content of which is incorporated by reference herein.

The portable power supply 10 may include a sensing structure (e.g., a switch engaged by a protrusion, a permanent magnet and Hall-effect sensor, or other structure) to sense the presence or absence of the outlet panel assembly 18.

With reference to FIGS. 1-3, the outlet panel assembly 18 is removably coupled to the housing 14. In the present embodiment, the outlet panel assembly 18 is connected to the front face 26 of the housing 14. The outlet panel assembly 18 is connected to the housing 14 by a plurality of fasteners 42. The present embodiment includes ten screws for removably attaching the outlet panel assembly 18 to the housing 14. Other quantities and types of fasteners can be used, such as bolts, clips, or the like. The outlet panel assembly 18 covers at least a majority of the opening 22. As shown in the present embodiment, the outlet panel assembly 18 covers the entirety of the opening 22.

With continued reference to FIGS. 2 and 3, a junction box 46 is coupled to and disposed in the housing 14 behind the outlet panel assembly 18. The junction box 46 includes a plurality of walls 50 that define a recess 54 having an opening 56 and a perimeter 58. The walls 50 of the junction box 46 separate the recess 54 from the cavity 30 of the housing 14. The perimeter 58 includes a plurality of fastening locations 62. The plurality of fasteners 42 removably connect the outlet panel assembly 18 to the junction box 46 at the plurality of fastening locations 62. The outlet panel assembly 18 may be connected to the fastening locations 62 by bolts, screws, or other fastening members. The recess 54 of the junction box 46 receives the outlet panel assembly 18.

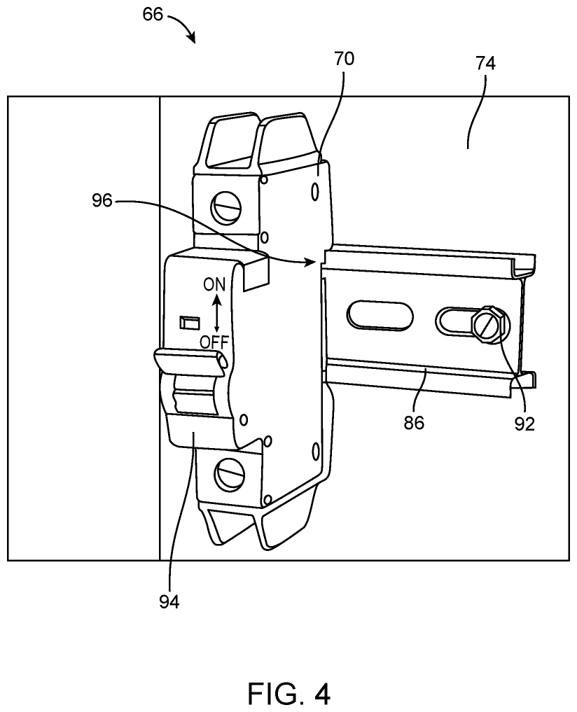

As illustrated in FIG. 4, a typical portable power supply 66 includes a circuit breaker 70 coupled to a wall 74 in a manner in which the circuit breaker 70 is not removable with a cover panel. For instance, a typical portable power supply 66 includes a rail 86 coupled to the wall 74 via a fastener 92. The circuit breaker 70 is includes a breaker housing 94 that includes a groove 96, or slot, that receives the rail 86 and couples the circuit breaker 70 to the rail 86.

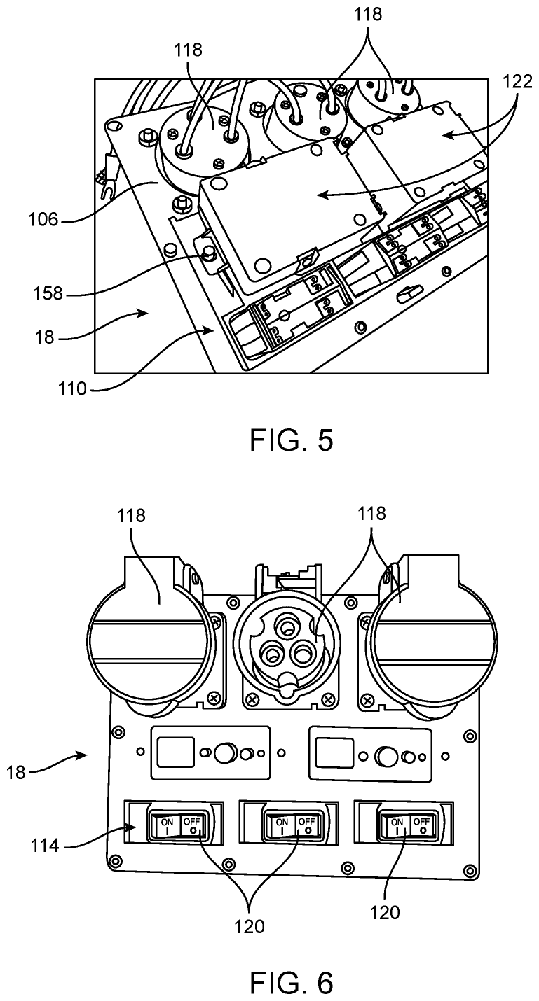

With reference to FIGS. 5 and 6, the outlet panel assembly 18 according to the present disclosure includes a panel 106 that defines a rear, or interior, side 110 and a front, or exterior, side 114. The panel 106 is coupled to the junction box 46 such that the rear side 110 of the panel 106 is facing the cavity 30. An outlet 118 (e.g., three outlets) and a current interrupt circuit 122 according to the present disclosure are mechanically coupled (e.g., with fasteners) to the panel 106, for instance, to the rear side 110, and are removable with the outlet panel assembly 18. In the present embodiment, the outlet panel assembly 18 may also include a switch 120 (e.g., three switches) for selectively disabling the electrical output of the outlet 118 (or of each respective outlet). The outlet 118 may be removably connected to the outlet panel assembly 18. The outlet panel assembly 18 is electrically coupled to the battery cells 34 (e.g., via wires 124, illustrated schematically in FIG. 1, that extend through the junction box 46 and may be coupled to an inverter, charging electronics, etc., in addition to the battery cells 34) for providing an electrical output to a power tool or other device that may be removably coupled to the outlet 118. The outlet 118 may be an AC or DC outlet. The portable power supply 10 may provide DC power while concurrently providing AC power to the outlet panel assembly 18.

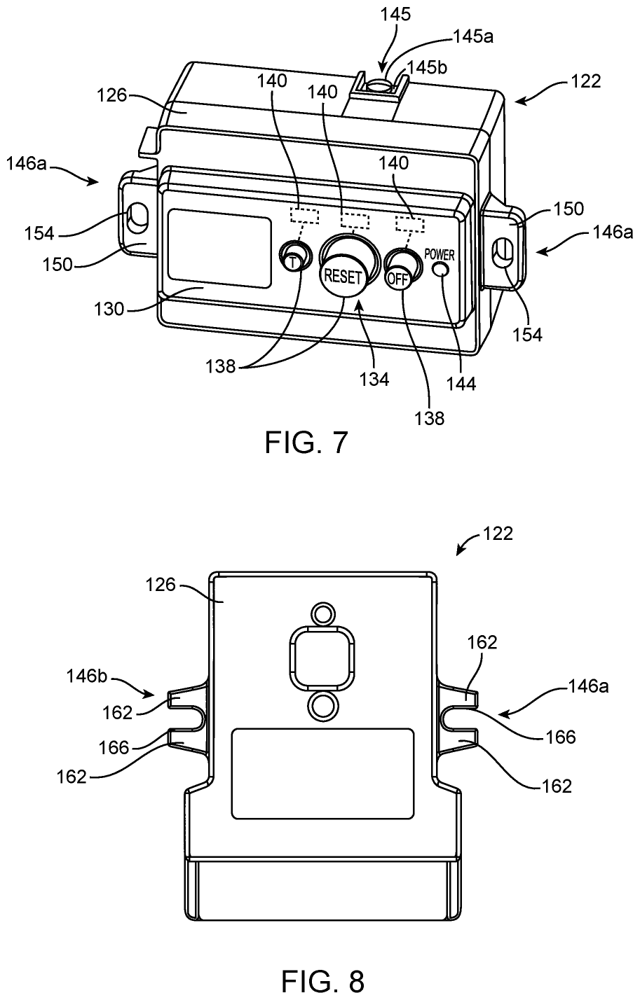

With reference to FIGS. 7 and 8, the current interrupt circuit 122 is supported in a body 126 that is coupled to the rear side 110 of the panel 106. The body 126 has a front face 130 that includes an interface 134 that engages the current interrupt circuit 122. As illustrated in FIG. 7, the interface 134 includes three buttons 138 that are engageable by a user and that engage switches 140 (internal to body 126, illustrated schematically) of the current interrupt circuit 122 for testing, resetting, and turning off the current interrupt circuit 122. The current interrupt circuit 122 also includes an indicator 144 (e.g., an LED) that indicates whether current is flowing through the current interrupt circuit 122 or whether the flow of current has been interrupted. In other embodiments, the body 126 may include other interface structures (e.g., a switch having on and off positions, an auditory signal, etc.), different combinations of buttons, etc. The body 126 also includes one or more electrical connectors 145 (e.g., a fastener 145a and electrically conductive backing plate 145b) for electrically coupling the current interrupt circuit 122 with the outlet 118, the battery cells 34, the circuit breaker 70, or other electrical structures of the portable power supply 10.

The body 126 includes one or more mount projections extending from the body 126. In one embodiment, shown in FIG. 7, the body 126 includes two mount projections 146a that extend from opposite sides of the body 126. Each mount projection 146a includes a tab 150 that has a hole 154 (e.g., a closed, obround hole) defined in the mount projection 146a. The hole 154 receives a fastener 158 (shown in FIG. 5) to couple (e.g., threadedly coupled) the current interrupt circuit 122 to the panel 106. In another embodiment, shown in FIG. 8, the body 126 includes two mount projections 146b that extend from opposite sides of the body 126. Each mount projection 146b includes a pair of arms 162 that have a slot 166 (e.g., an open-ended slot) defined between the arms 162. The slot 166 receives a fastener 158 to couple (e.g., threadedly coupled) the current interrupt circuit 122 to the panel 106. The mount projections 146a, 146b in FIGS. 7 and 8 are illustrated as extending from the lateral sides of the body 126 (that is, the left and right sides, as illustrated in FIGS. 7 and 8). In other embodiments, the mount projections 146a, 146b may extend from the top and bottom sides as illustrated in FIGS. 7 and 8, or the front or rear sides. In other embodiments, the body 126 may include other structures (e.g., a clip extending from the panel 106 and engaging a tab extending from the body 126 to couple the current interrupt circuit 122 to the panel 106. In some embodiments, the body 126 may include a sealing interface disposed between the body 126 and the panel 106 to reduce the ingress of water, dust, or the like into the housing 14.

The current interrupt circuit 122 is mechanically coupled to the panel 106 at least partially between the outlets 118 and switches 120. In other embodiments, the current interrupt circuit 122, outlet 118, and switch 120 may be coupled to the panel 106 in other arrangements. The body 126 is coupled to the panel 106 such that a majority of the body 126 is disposed on the rear side 110 of the panel 106 and the interface 134 is disposed on the front side 114 of the panel 106. The body 126 may instead be supported with a majority of the body 126 disposed on the front side 114 of the panel 106.

The current interrupt circuit 122 automatically interrupts a connection to the outlet 118 when a current exceeds a predefined threshold (e.g., an overcurrent) or a fault condition (e.g., a ground fault) occurs. The current interrupt circuit 122 may be a residual current device (“RCD”) such as a residual current circuit breaker (“RCCB”). The current interrupt circuit 122 may instead be a ground fault circuit interrupter (“GFCI”). The current interrupt circuit 122 may instead be a fuse, or other structure that permits a flow of current from the battery cells 34 to one or more outlets 118 and automatically interrupts a connection from the battery cells 34 to one or more outlets 118. The current interrupt circuit 122 may automatically interrupt a flow of current to an outlet 118 when an event occurs that is indicative of a ground leakage or ground fault. The current interrupt circuit 122 may instead automatically interrupt a flow of current to an outlet 118 when an event occurs that is indicative of a short circuit. The current interrupt circuit may instead automatically interrupt a flow of current to an outlet 118 in an event that is indicative of an arc fault. The current interrupt circuit 122 may instead automatically interrupt a connection from the battery cells 34 to one or more outlet 118 when a current exceeds a predefined threshold (e.g., a threshold for safe operation of the portable power supply 10 or a power tool or other device electrically coupled to the portable power supply 10). The current interrupt circuit 122 may be rated at a current of 20 amps, with a rated voltage of 100 to 250 volts-alternating-current, with a frequency of 50 Hz or 60 Hz, with a residual operating current of 30 milliamps and a residual non-operating current of 15 milliamps. The current interrupt circuit 122 may be a Type-A RCD.

It will be appreciated that a current interrupt circuit 122 of the present embodiment, in which the current interrupt circuit 122 is removable with the outlet panel assembly 82 facilitates servicing the current interrupt circuit 122 with the outlet panel assembly 82. It will also be appreciated by those skilled in the art that coupling the current interrupt circuit 122 to the outlet panel assembly 82 optimizes space within the recess 54 defined by the junction box 46 by, for instance, reducing the depth of the recess 54 required to house the current interrupt circuit 122, outlets 118, switches 120, and other components. Coupling the current interrupt circuit 122 with the outlet panel assembly 82 also reduces manufacturing complexity by reducing the quantity of parts and the number of assembly steps.

1. A portable power supply comprising:
a housing defining a cavity therein;
a plurality of battery cells disposed in the housing; and
an outlet panel assembly removably coupled to the housing, the outlet panel assembly including
a panel,
an outlet mechanically coupled to the panel and electrically coupled to the battery cells, and
a current interrupt circuit mechanically coupled to the panel and electrically coupled to the plurality of battery cells and to the outlet.

2. The portable power supply of claim 1, wherein the panel defines an interior side facing the cavity, and the current interrupt circuit is coupled to the panel on the interior side.

3. The portable power supply of claim 1, wherein the current interrupt circuit automatically interrupts a connection to the outlet when an overcurrent condition or a fault occurs.

4. The portable power supply of claim 1, wherein the current interrupt circuit includes a ground fault circuit interrupter.

5. The portable power supply of claim 1, wherein the current interrupt circuit includes a residual current device.

6. The portable power supply of claim 5, wherein the current interrupt circuit includes a residual current circuit breaker.

7. The portable power supply of claim 1, wherein the current interrupt circuit is housed in a body, the body includes a mount projection.

8. The portable power supply of claim 7, wherein the mount projection includes a tab having a hole defined therein.

9. The portable power supply of claim 7, wherein the mount projection includes a pair of arms and a slot defined between the arms.

10. The portable power supply of claim 1, wherein the current interrupt circuit includes a reset switch that is engageable by a user.

11. The portable power supply of claim 1, further comprising a junction box coupled to the housing, the junction box defining an opening, the outlet panel assembly coupled to the junction box and at least partially covering the opening.

12. The portable power supply of claim 11, wherein the junction box defines a recess and the current interrupt circuit is disposed in the recess.

13. An outlet panel assembly comprising:
a panel;
an outlet coupled to the panel;
a switch coupled to the panel; and
a current interrupt circuit coupled to the panel, the current interrupt circuit disposed at least partially between the outlet and the switch.

14. The outlet panel assembly of claim 13, wherein the current interrupt circuit is disposed in a body, the current interrupt circuit includes an interface, and the current interrupt circuit is mounted such that a majority of the body is disposed on a rear side of the panel and the interface is disposed on a front side of the panel.

15. The outlet panel assembly of claim 14, wherein the current interrupt circuit is coupled to the rear side of the panel.

16. The outlet panel assembly of claim 14, wherein the body includes a mount projection having a tab having a hole defined therein.

17. The outlet panel assembly of claim 14, wherein the body includes a mount projection having a pair of arms and a slot defined between the arms.

18. A portable power supply comprising:
a housing including a cavity defined therein;
a plurality of battery cells disposed in the cavity;
a junction box coupled to the housing, the junction box including a plurality of walls defining a recess, the walls separating the recess from the cavity;
an outlet panel defining a rear side, the outlet panel coupled to the junction box and at least partially covering the recess, the rear side facing the recess;
an outlet coupled to the outlet panel, the outlet electrically coupled to the plurality of battery cells; and
a current interrupt circuit coupled to the outlet panel and electrically coupled to the outlet and the battery cells.

19. The portable power supply of claim 18, wherein the current interrupt circuit is supported in a body, the body includes a mount projection, the mount projection includes a tab having a hole defined therein.

20. The portable power supply of claim 18, wherein the current interrupt circuit is supported in a body, the body includes a mount projection, the mount projection includes a pair of arms having a slot defined therebetween.
